(19) United States
(12) Patent Application Publication
(10) Pub. No.: US 2006/0088042 A1
(43) Pub. Date: Apr. 27, 2006

(54) Method, system and devices for creating spontaneous electronic information propagation and retrieval

(75) Inventors: Eran Shoham, Rishon Lezion (IL); Yaakov Ostrover, Netanya (IL)

Correspondence Address: DR. MARK FRIEDMAN LTD.;C/o Bill Polkinghorn, 9003 Florin Way, Upper Marlboro, MD, 20772, US

(73) Assignee: NIMROD BOROSH EL AL.

(21) Appl. No.: 11/250,437

(22) Filed: Oct. 17, 2005

Related U.S. Application Data
(60) Provisional application No. 60/621,058, filed on Oct. 25, 2004.

(51) Int. Cl. H04J 3/22

(52) U.S. Cl. 370/401; 370/465

(57) ABSTRACT

A system and method for spontaneous electronic information propagation and retrieval. The system comprises a plurality of devices operative to propagate information and to autonomously recognize and analyze the information; and a propagation mechanism that includes a special communication protocol (SCP). The SCP and the autonomous recognition and analysis of the information render the system free of any device recognition, registration or administration and free of a network coordinator or any device management element that operates as a mandatory condition for enabling the communication.

### CROSS REFERENCE TO RELATED APPLICATIONS

The present invention claims priority from U.S. Provisional Patent Application No. 60/621,058 filed Oct. 25, 2004, the content of which is incorporated herein by reference.

### FIELD AND BACKGROUND OF THE INVENTION

The present invention relates generally to communication systems and more specifically to management of information exchange, propagation and retrieval in electronic information systems and networks.

Any known electronic information network system activates a mandatory inclusive device-recognition mechanism as a fundamental and imperative component of its method of exchanging information. Devices not recognized and registered by the system as network members cannot participate at all in its information exchange. Such systems are ‘closed’ systems in the sense that they allow information exchange for inclusive authenticated recognized devices only. Furthermore, in prior art, electronic information networks include mechanisms that act as “Network Coordinators or NCs” for uniquely administrating and recognizing their devices identification.

Various types of information systems working on different types of networks with different topologies are known. The term Network Coordinator may vary in these systems, assuming names such as Server, Network Controller, etc. In some server-based systems, the network operation is dependent on dedicated servers. In other systems, the network operation is not dependent on any one server. In yet other systems such as peer-to-peer (P2P), clients forming the network act as NCs by accepting or rejecting new network devices. In all such systems, every action of sending and receiving information from one member to another must be based on the system's inclusive recognition of a SOURCE and a DESTINATION unique identification of each device.

C. Hunt in “TC/IP Network Administration”, ISBN: 0-596-00297-, April 2002, chapter 1.1.1 “TCP/IP Features”, states: “A common addressing scheme that allows any TCP/IP device to uniquely address any other device in the entire network, even if the network is as large as the worldwide Internet”, i.e. each device has to address any other device in order to establish communication.

W. C. Craig in a white paper “ZigBee: “Wireless Control That Simply Works” states re. the NC of a wireless network: As can be seen also in wireless systems, their Network Coordinator is a standard mechanism. In ZigBee there is a definite distinction between two types of devices: FFD—Full Function Device and RFD—Reduced Function Device. One of the main characteristics of an FFD is that it is capable of being a NC. That topology is a clear ‘closed’ system that must recognize registered members in order to perform information exchange. “ZigBee defines the network, security, and application framework profile layers for an IEEE 802.15.4-based system. An IEEE 802.15.4 network requires at least one FFD to act as a network coordinator. The coordinator initializes a network, manages network nodes, and stores network node information. The ZigBee Router participates in the network by routing messages between paired nodes. The ZigBee End Device acts as a leaf node in the network and can be an RFD or FFD. ZigBee application device types distinguish the type of device from an end-user perspective as specified by the Application Profiles.”

P. Kinney in “ZigBee Technology: Wireless Control that Simply Works” relates to the fact that such a system requires at least one full function device as a network coordinator and specifically of the NC in relation to P2P, which requires SOURCE/DESTINATION identifier. To quote:

“An IEEE 802.15.4/ZigBee network requires at least one full function device as a network coordinator, but endpoint devices may be reduced functionality devices to reduce system cost. All devices must have 64 bit IEEE addresses:

Short (16 bit) addresses can be allocated to reduce packet size

Addressing modes:

Network+device identifier (star)

SOURCE/DESTINATION identifier (peer-peer)”

J. D. Larsen et al, in patent applications WO9856140 and U.S. Pat. No. 6,785,510 disclose a system and method of relaying data between mobile stations in a cellular communications system. The system comprises a number of mobile stations and base stations. Each base station makes synchronization transmissions within its area of coverage, which define a broadcast control channel for the transmission of broadcast data from the base station to mobile stations. The synchronization transmissions are received at mobile stations within the area of coverage, which extracts data defining the broadcast control channel, and at least one calling channel on which mobile stations can transmit probe data to one another. The probe data is used by the mobile stations to obtain connectivity information relating to the availability of other mobile stations. The synchronization transmissions also contain data used to define at least one traffic channel which is used by the mobile stations to relay message data between themselves. Effectively, the method of the invention provides a hybrid system that combines conventional cellular technology with opportunistic relaying technology.

A major disadvantage of the Larsen et al. method lies in the obligatory need of a mobile station to identify a base station in order to transfer information. The Larsen et al. method presents an obligatory need to identify a destination station and other connecting intermediate stations in order to be able to transfer information to the destination stations.

The limitations and disadvantages of the ‘closed’ systems is that they are restricted to recognized devices and require the implementation of costly network administration and management and backbone systems. This is needed even in order to perform simple network transactions. Such network administration creates a large overhead for communications between devices. For example, in the Internet, the management of users and the administration of IP addresses occupy a very large part of the entire system.

All prior art information systems are thus similar in that they have an inclusive mechanism that manages the network devices. These systems cannot enable information exchange without uniquely recognizing these devices. This recognition includes prerecognition of all the paths/routes from a source device to a destination device. The action of recognition includes an active search for the destination address and the intermediate devices/stations, which are part of the path. This pre-recognition also means that the NC has a mechanism that must “know” a unique address of each device in order to enable communication. This is true even for a mobile “ad-hoc” network, defined as “a peer-to-peer wireless network that transmits from computer to computer without the use of a central base station (access point). Routing from one node to another on such a network requires an on-demand routing protocol, such as DSR or AODV, which generates routing information only when a station initiates a transmission”. Ad-hoc networks are described in “Mobile Ad Hoc Networks” by Hridesh Rajan, Dept of Computer Science, University of Virginia, September 2001. As stated therein: “Most routing protocols for mobile ad hoc networks maintain routing information similar to their static counterparts” and “some algorithms such as GRID and DREAM use geographic location for routing. These algorithms maintain the location information for other nodes in the network in the routing table. Each node has its location information”. Thus, these networks require either routing or location mechanisms. The on-demand routing protocols implement routing tables in order to enable communication among the nodes. Such a network also uses routing daemons (servers) in order to maintain network members. Each new member recognized by the system must be registered as a new member in a routing table.

Flooding algorithms are also known. A flooding algorithm propagates information by sending on data from one device to another, but this distribution is to all of the devices and does not contain any autonomous recognition mechanism by device(s) and doesn't check if the messages are addressed specifically to them or to a group they belong to or addressed to them according to another matched criterion. More advanced flooding algorithms are being used in routing systems where data is being used in more than one route. There is no known system that uses “flooding” with device autonomous recognition mechanism.

Furthermore, the prior-art uses the OSI (Open System Interconnection) model to transfer information between devices in a standard, uniform way. When information output is sent from a device through the communication media it is connected to, it is transmitted in BROADCAST form, which means that at that point every connected device receives the information. However, before the information reaches any device it goes through the 2^{nd} layer of the OSI model—the DATA LINK, where the sendee's and sender's unique MAC ADDRESS are being checked. The information then goes through the 3 _{rd} and 4^{th} layers that deal with network and transport, until reaching the 7^{th} layer where sent data is revealed only to the sendee. Other devices that are not sendees do not receive the information.

Existing large networks with administration and backbone systems require the availability of large physical infrastructures. That creates less flexibility in system deployment in locations where such infrastructure is absent or is very hard to build and install. Build-up, set-up time, support and maintenance of such systems are quite costly.

There is thus a widely recognized need for, and it would be highly advantageous to have, a system, method and devices for creating spontaneous electronic information propagation and retrieval devoid of the above limitations and disadvantages. In particular, it is advantageous that such system, method and devices should operate without routing or location mechanisms and without management by a network coordinator.

### SUMMARY OF THE INVENTION

The present invention discloses a spontaneous electronic information propagation and retrieval system and method comprising electronic devices having mechanisms capable of creating processing and storing electronic information, capable of sending and receiving electronic information, and carrying compatible ‘send’ and ‘receive’ information protocols working with various methods of communication. The invention provides a synchronization capability for the electronic information being sent and received by the devices. The devices carry rules, criteria for handling received and sent information and parameters and are operative to process and communicate information. The system further comprises decentralized means (e.g., a software (SW) application) operative to propagate and retrieve the electronic information between at least two devices. In the present invention the emphasis is on the information itself, not where it is located or who has it. Therefore, when devices send and receive information, they are completely free from the need to be aware of the presence of other devices as part of the communication process. The system is thus free of any device recognition, registration with the system or device administration. Further, the system itself is free of a ‘Network Coordinator’.

In contrast with prior art, the present invention does not use any network management, does not activate any recognition of any other device(s) and therefore does not create and does not manage routes/paths in order to communicate (as done in ad-hoc systems). In further contrast with ad-hoc systems, the present invention does not use any routing tables, routing lists or device recognition.

The information in the present invention is sent under the assumption that it will propagate and reach its destination (due to the fact that the addressee device(s) will recognize their own address and/or other parameters and read the information). In some embodiments (mainly in wireless- communication), devices disclosed herein may optionally check for neighboring devices in order to determine if there are any near devices at all. This check may be done for purposes of controlling factors like broadcast range adjustments, power consumption control and error messaging. In contrast with prior art, there is no device address recognition or routing for enabling communication in any embodiment.

In one embodiment, the method comprises a step in which a device sends a message. The message may include an informative content parameter and/or a rule or criteria and/or a unique identifier (ID) and/or a group ID. The message may also include other types of data such as a request for information, an affirmation and informative content. The method further comprises a step in which at least one other device receives the message, both the sending and the at least one receiving device using a special communication protocol to handle the message. The method further comprises a step in which the at least one receiving device reads the message and activates an autonomous recognition mechanism by which according to device's defined rules and criteria, determines one or more reactions. The reactions may include one or more of the following:

a) sending-on the received information as-is, thus enabling the propagation of information to be received by at least one other device that keeps on performing a similar reaction.

b) analyzing the received information, searching for corresponding existing information and, if finding it, retrieving and sending the retrieved information, when the received information is a request for information.

c) manipulating, storing and displaying the information, when the received information carries information corresponding to the receiving device's criteria, rules and parameters.

d) manipulating, storing and/or displaying the information, when the received information is retrieved information sent by other devices corresponding to a request for information originally sent by the receiving device, by recognizing its own enclosed ID.

e) analyzing received information which includes two unique ID parameters, the receiving device's own unique ID and the sending device's unique ID, searching for corresponding existing information and sending the retrieved information together with both unique ID parameters if the received and existing information match. This represents an exclusive connection of devices.

f) when the received information includes at least one group ID, analyzing the information, searching for corresponding existing information and sending retrieved information together with the unique group ID(s) parameter(s). This represents a group connection amongst devices.

g) when the received information includes informative content and/or other parameters like date and time, analyzing the information searching for matched data according to defined device's rules and/or criteria related to matching and processing the information according device's rules and/or criteria related to processing. This represents a rule-based connection amongst devices.

The security of information in the reactions and in particular in exclusive and group connections may be obtained by implementing on each device known security methods such as public key, private key, EIS and Secure Sockets Layer (SSL) and hopping codes algorithms for data encryption, enabling encoding and decoding of the information on devices.

In some embodiments, the method may comprise a step in which a “receive only” device receives sent information such as messages and determines, according to its own rules and criteria, one or more reactions. Such reactions may include storing and/or displaying the received information, when the received information includes a matching own unique ID or group ID(s) parameter or matched informative content according to defined device's rules and/or criteria.

In some embodiments, the method may comprise a step in which a “send only” device determines, according to its own rules and criteria, one or more reactions. Such reactions may include sending information that includes a parameter such as other devices' ID and/or group ID(s) and/or parameters or sending information without other devices' parameters.

The propagation mechanism preferably includes a timeout and a send-check mechanism, whereby each device checks if a received packet already exists and if it does, rejects the request; each device also checks the packet's timeout and the packet's hopping restrictions, and if it has expired, it eliminates the request. If the packet is a new packet, the device relates to the information content and enclosed IDs according to its own rules, criteria and parameters.

Many other variations of the method steps are possible, especially regarding rules and parameters. For example rules and parameters may evoke sending on revised, manipulated and/or additional messages, delayed messages, timed depended messages, etc. A rule can relate to specific types of groups and set application actions accordingly.

According to the present invention there is provided a method for creating spontaneous electronic information propagation and retrieval comprising the steps of: by a first device, sending electronic information using a special communications protocol (SCP); in at least one second device, receiving the electronic information; in each second device in which the information was received, recognizing and analyzing the electronic information autonomously using the SCP, thereby obtaining autonomous analysis results; and, by each second device, performing at least one action in response to the autonomous analysis results, whereby the SPC and the autonomous recognition and analysis of the information render the electronic information propagation and retrieval free of any need for device recognition, registration or administration and whereby the method is performed without including actions by a network coordinator.

According to the present invention there is provided a method for creating spontaneous electronic information propagation and retrieval comprising the steps of: providing a plurality of devices, each device operative to perform autonomous data creation, recognition, analysis and communication; and propagating the electronic information from device to device, wherein each device is free of any awareness of the presence of other devices while performing the propagation.

According to the present invention there is provided a system for spontaneous electronic information propagation and retrieval comprising a plurality of devices, each operative to autonomously recognize and analyze sent and received electronic information, and a propagation mechanism operative to propagate the electronic information from device to device, wherein each device is free of any awareness of the presence of other devices.

### BRIEF DESCRIPTION OF THE DRAWINGS

The present invention is described herein by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the present invention. In the drawings:

FIG. 1 shows schematically a system for information propagation and retrieval according to the present invention that comprises “send and receive” devices;

FIG. 2 shows a flow chart of the process of information propagation and retrieval according to the present invention; using the system of FIG. 1: a) in the most general and basic steps; and b) in more detail;

FIG. 3 shows schematically a very detailed and enhanced example of a process as in FIG. 2:

FIG. 4 shows in (a) a definition of the bits format of the transmitted message and in (b) a definition of a valid bit reception test

### DETAILED DESCRIPTION OF THE PREFERRED EMBODIMENTS

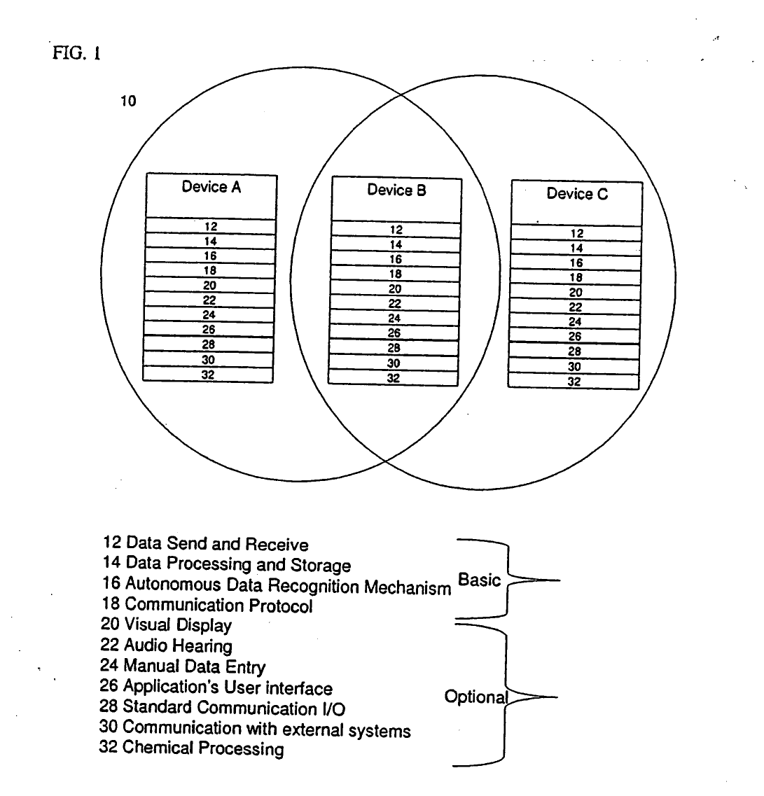

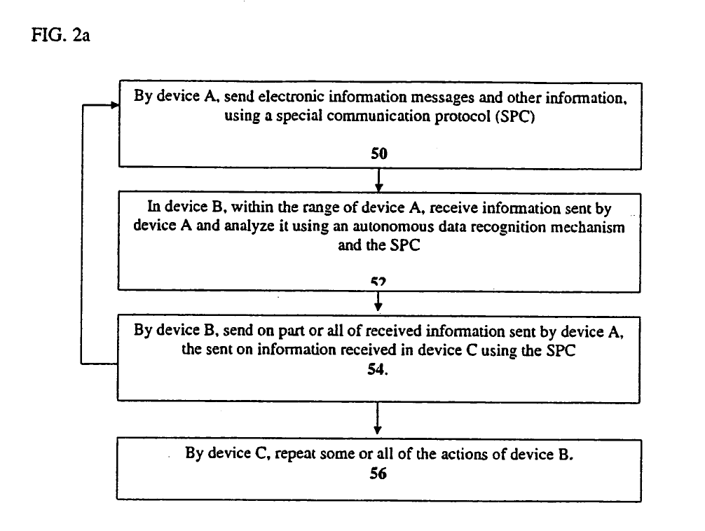

FIG. 1 shows schematically a system 10 for information propagation and retrieval in a system according to the present invention. The system is shown exemplarily to comprise three devices A, B and C, each operative to send and/or receive data and process and store data. Each device is further operative to use a compatible special communication protocol (described below) and to operate an autonomous data recognition mechanism. In FIG. 1, the communication is exemplarily performed by wireless radio (not shown), and the three devices communicate exemplarily on the same frequency. In inventive difference with prior art, each device is completely free from the need to be aware of the presence of other devices as part of the communication process. This unique and inventive functionality is expressed in the autonomous data recognition mechanism and the special protocol. The system itself is thus free of any device recognition, registration or administration needs and functions. Further, the system is free of the need for a ‘Network Coordinator’.

Devices disclosed herein may be optionally operative to check for neighboring devices in order to determine if there are any near devices at all. This check may be done for purposes of controlling factors like broadcast range adjustments, power consumption control and error messaging, yet there is no device address recognition or routing in any embodiment.

In FIG. 1, devices A and B are within the same range (“coverage area”, schematically illustrated by a circle) and devices B and C are within another coverage area. “Coverage area” in this context means not only a physical entity (as in wireless communications) but also an abstract entity, meaning that information sent by device A is received by device B and vice-versa. Devices A and C are not within the same coverage area and cannot therefore receive directly each other's sent information. It should be apparent to one skilled in the art that a general system of the present invention may include any number N of devices (N≧2), at least two of which overlap in their area of coverage. In other words, each coverage area includes a plurality of devices, at least one of which devices is also included in at least one other coverage area. The physical area covered by this deployment of devices is not limited, and may encompass the entire world, as exemplarily done by the Internet.

Each device of the system comprises a number of mandatory modules or “functions” to provide a basic functionality. Exemplarily, a “send and receive” device comprises a data send and a data receive module 12. Module 12 is operative to perform the actions of sending data outside the device and receiving data from outside the device. The sending and receiving may be done using a variety of methods. A send and receive device further comprises a “data processing and storage” module 14 operative to perform data processing, data creation, data reading and data storage using a variety of data processing and storage methods. The data storage period may last from less than one millisecond to permanent storage.

A send and receive device further comprises an “autonomous data recognition mechanism” module 16 operative to manage parameters, rules and criteria that determine the way in which received and sent information is matched, searched and manipulated. Module 16 is also operative to perform searches of existing data and parameters stored on the device and to match data and parameters found in such a search with received data elements. In particular, module 16 is operative to check matches between a device's own (internal) identifier (ID) parameter and ID parameters enclosed in incoming data, as well as matches between a device's own group ID parameter and group ID parameters enclosed in incoming data. Module 16 is further operative to check informative data matches performed according to defined device rules and criteria utilizing the device's own rules and criteria, to determine further actions. In contrast with prior art data recognition mechanisms, the “autonomous data recognition mechanism” does not comprise and does not operate any network management function, does not activate any recognition of any other device(s) and therefore does not create and does not manage routes/paths in order to communicate (as done in ad-hoc systems). In this sense, the autonomous data recognition mechanism of the present invention is a “simplified” data recognition mechanism.

Note that in some embodiments, one or more of modules 12-16 may be missing from a device. For example, in a “send only” device, module 12 may be missing the data receive part. In a “receive only” device, module 12 may be missing the data send part.

A send and receive device further comprises a “communication protocol” module 18 operative to handle the data communication amongst devices. This handling is done without using any functions responsible for network route management and device recognition as part of the communication process. In this sense, the communication protocol module of the present invention is a “special” communication protocol (SCP) module. As explained below, known in the art communication protocols may have some of their network route management and device recognition functions removed to become “simplified” protocols that can act as a SCP of the present invention.

In some embodiments, the functionality of a device of the present invention may be further expanded by the device comprising one or more optional functions. Exemplarily, a “send and receive” device may further comprise a “visual display” module 20 operative to perform visual display using a variety of visual display methods; an “audio hearing” module 22 operative to perform audio hearing using a variety of audio hearing methods; a “manual data entry” module 24 operative to perform manual data entry using a variety of manual data entry methods; an “application's user interface” module 26 operative to perform application's user interface using a variety of application's user interface methods; a “standard communication input/output (10)” module 28 operative to perform standard communication I/O using a variety of standard communication I/O methods; a “communication with external systems” module 30 operative to perform communication with external systems using a variety of communication with external systems methods; and a “biochemical processing” module 32 operative to perform biochemical processing using a variety of biochemical processing methods;

A major inventive difference between system 10 and prior art systems is that a prior art system comprises a device management element that manages device ID lists or device locations as a mandatory condition for enabling communication, The device IDs must be registered on such a list and must be recognized by being matched to that list in order for the devices to participate in the communication process. A device that does not appear on such a list cannot participate in the communication process. In some prior art systems such as P2P, such list management is performed in servers, probes or master devices, where a mutual recognition occurs between them and client or slave devices as a mandatory condition for enabling communication. In other prior art systems such as “ad-hoc”, a similar device management element operates on scattered devices carrying the same type of lists of devices, sometimes called routing tables, performing the same type of device ID matching as a mandatory condition for enabling communication. In inventive contrast and advantageously, the system of the present invention does not comprise any device management element that operates as a mandatory condition for enabling communication. Though a device in the system disclosed herein may store other device IDs from time to time during its operation, this type of data serves as an address book and is not being used for any communication control. This means that a user can send a message with an enclosed ID of another device destined to arrive to that device, with no need to have the other device ID appear on any list or be recognized by any other device. The system disclosed herein uses autonomous data recognition mechanism module 16 as the sole system element for communication. In contrast with prior art, module 16 does not use any mandatory device list for device recognition.

A device of system 10 may be a computer, a personal digital assistant, a mobile phone, a smart phone having computer capabilities, a smart object, a smart watch, a games console, a bio- or chemo-chip, a wireless sensor node, a dedicated device, a combination of existing devices (e.g. an electronic display screen connected to a device capable of receiving electronic information), an add-on to an existing device (e.g. a digital camera connected to a device capable of sending electronic information) or any other electronic device with similar capabilities (e.g., a DVD or TV set). The device is preferably capable of connecting to other information systems, for example to the Internet, an Intranet, a LAN, a WAN, WLAN, workgroups and data warehouses.

The electronic information may include digital data, analog data and a combination thereof. The data may be in a format such as files, indexed files, access methods, databases or any other form of technology that entails similar capabilities. The data may be provided as or include text, images, video, sound, as well as information obtained by sensors such as bio- and chemical-sensor chips. The information may be transmitted by electromagnetic waves of any wavelength.

Data processing and storage module 14 may be based on magnetic media, optical media, microchips or any other form of electronic storage technology that entails similar capabilities. The storage may be for any period of time from less than milliseconds to permanent storage.

The parameters, rules and criteria in module 16 may include: a) information filtering rules that define the type of content of interest or of no interest and b) rules about the type of information allowed to be sent. The rules and criteria may have similarity to search engines filters, e-mail filter rules and criteria and firewall applications.

Data Send and Receive module 12 may use technologies such as Radio Frequency (RF), Infra-Red, code division multiple access (CDMA), GSM, GPRS, optical gateway, cable modem, Ethernet and bio- or chemo-chip information transfer technology for their functions.

Data processing and storage module 14 may include a software (SW) application or hardware (HW) mechanism capable of working on the device. This mechanism may be capable of inserting new electronic information, defining parameters and/or rules for the mechanism for processing electronic information, defining criteria for data searching and/or storage, and defining matching parameters such as identification (ID) parameters, informative content parameters, or hierarchical identification. An exemplary identification parameter may be a unique ID such as a MAC address, or a group ID such as an organization's ID. Devices carrying such a group ID are able to receive messages addressed to that group. An informative content parameter may include for example key words. A hierarchical ID parameter may include for example groups sequentially contained in the each other, e.g.: “All warehouses W”, “Warehouse W1”, “Section S1”, “Shelve S1200”, and “Item IT2300”. The usage of such hierarchical groups may leverage the efficiency of computing power in data collection of a large number of scattered items with RFID tags. One example includes items counting in an RFID logistical environment where some of the devices are multiple numbers of scattered computers. When such a computer device receives a message with a non-matched group ID on a higher hierarchy level, it needs less computing power for the matching process than in allocating a very large number of single items. On the other hand, the computer devices that find matches for the mentioned top hierarchy level group ID are able to perform the matching and items counting more efficiently and easier to access counting summation by the hierarchical groups IDs.

A yet another major inventive element of system 10 is that it is a communication system operative to perform 1:1 communication, group communication and information retrieval amongst devices without having to establish any path or handshake with other devices as part of the communication process.

The communication between devices may occur through a short, medium and long-range cable-based infrastructure, satellite infrastructure, near frequency and wireless communication of all kinds.

In some embodiments, the devices may be operative to listen in order to detect if neighboring device(s) are available. Each device may be operative to constantly sniff sent signals and measure hopping. This may provide a device with an indication of an available neighboring device within its coverage range. Before any broadcast, the device will thus have an indication if there is at least one device within its range.

The hopping measurement as part of this “neighboring device recognition” enables devices to control the power used for broadcast, depending on the distance of the closes neighboring device. The device may thus adapt the power required for sending according to the measured distance, to a defined maximal range. As such, this has important implications for a low radiation environment.

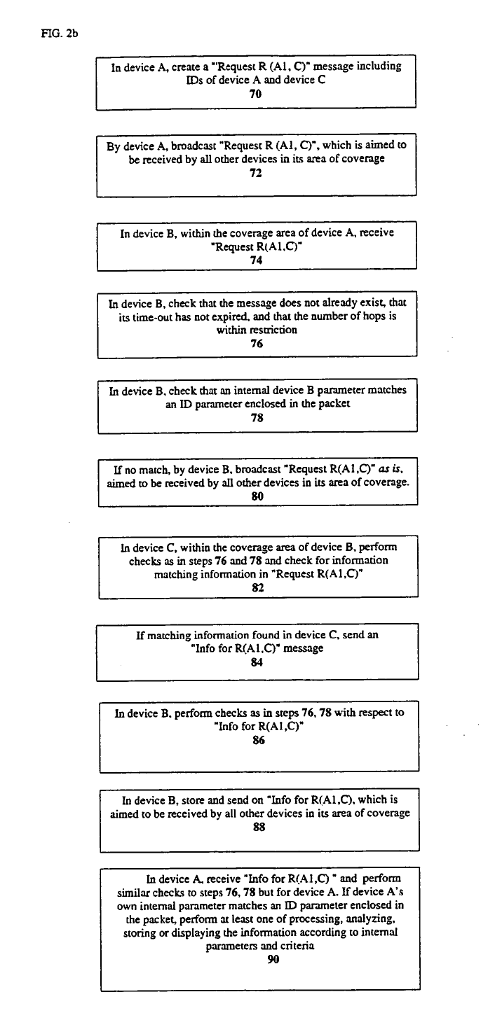

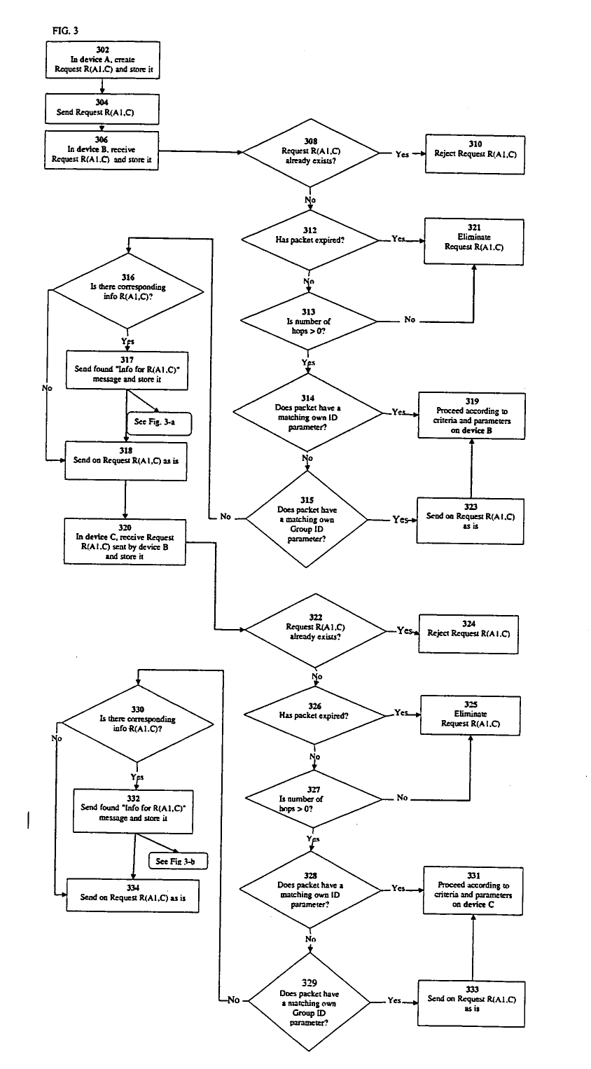

FIG. 2 shows in (a) in the most general and basic steps and (b) in more detail, flow charts of the process of information propagation and retrieval according to the present invention using the system of FIG. 1:

In use, in step 50, device A sends electronic information using a SCP. The information includes messages. Each message may include no ID parameter at all, a unique ID parameter and/or a group ID parameter, or other matching criteria. The message may also include other types of data such as a “request for information”, an affirmation and/or informative content. In step 52, the information sent by device A is received in device B (which is within their common coverage area) and analyzed using autonomous data recognition mechanism module 16. Based on the results of the analysis, in step 54 device B sends on all or part of the information sent by device A using the same SCP. The actions of device B are performed autonomously, without using any devices control or recognition and without any network control or routing mechanism. The information sent by device B is received in device C (which shares a common coverage area with device B but not with device A) and analyzed (in device C) using autonomous data recognition mechanism module 16. In step 56, device C repeats some or all of the actions of device B. As in device B, all actions are performed autonomously, without using any devices control or recognition and without any network control or routing mechanism. It would be apparent to one skilled in the art that this process may be repeated when the number of devices in the system is N.

FIG. 2b gives more details of the process of FIG. 2a. In step 70, a request for information message ‘Request R’ is created in device A and IDs of device A (A1) and device C (C) are enclosed in Request R, which becomes Request R(A1,C). Device A then sends Request R(A1,C) in step 72, to be received by all other devices in its coverage area. Device B receives Request R(A1,C) in step 74, and checks that the message does not already exist, that its time-out has not expired, and that the number of hops is within restriction in step 76. Note that each device may carry (store) informative content and other types of information that has arrived previously from other devices or was manually created or received from external systems. Some of this information may be used in the matching checks described herein, whenever these checks occur.

Based on the check results, device B autonomously decides on further actions. If the checks of step 76 are valid, device B checks its own internal ID against the ID(s) enclosed in the packet in step 78. If its own ID is not found in the received packet, device B sends Request R(A1,C) “as is” in step 80. Inventively, and in contrast with prior art, the actions of device B represent self-controlled actions performed autonomously, without use of any devices control or recognition and without any network control or routing mechanism.

Device C receives Request R(A1,C) and repeats the actions performed in steps 76-78, adjusted to reflect the differences between itself and device B (i.e. checking its own ID against that carried in the Request R(A1,C) package, etc.). In step 82, device C then checks its own device for existing corresponding (matching) internal information for Request R(A1,C). If it finds such matching information (a validly checked packet as in step 76), device C sends a found information “Info for R(A1,C)” message in step 84. Device B (and in the general case, all other devices in a common coverage area with device C,) receives “Info for R(A1,C)” and repeats the same checks done previously for Request R(A1,C) in steps 76, 78, this time with respect to “Info for R(A1,C). Based on these checks, if “Info for R(A1,C)” is valid, device B sends it on in step 88. Device A receives “Info for R(A1,C)” and repeats the same checks done previously for Request R(A1,C) in step 76,78, this time with respect to “Info for R(A1,C). If “Info for R(A1,C)” is valid and verified as information aimed to device A, then according to its own defined rules, criteria and parameters, device A performs at least one action selected from the group consisting of processing, analyzing, storing and displaying the information in step 90.

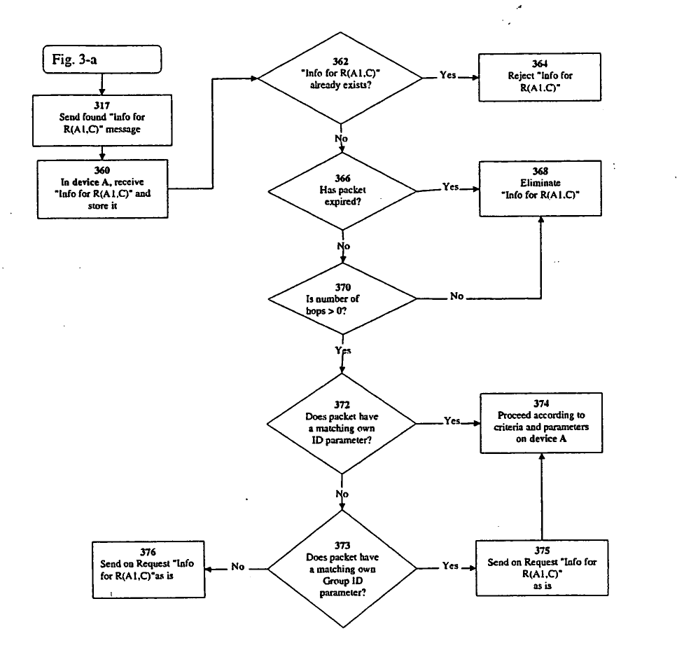

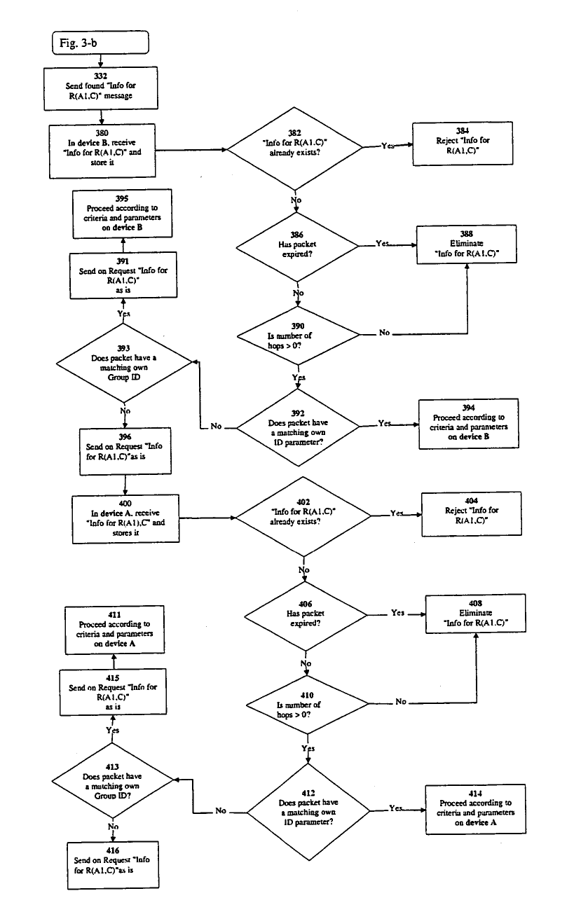

FIG. 3 shows schematically a very detailed exemplary process that expands on the process in FIGS. 2a, b. In step 302, Request R is created and stored in device A and ID (A1) of device A and ID (C) of device C are enclosed (and integrated) in Request R, forming Request R(A1,C). Device A then sends Request R(A1,C) in step 304. Device B receives Request R(A1,C) and stores it in step 306 and checks if it already has it in step 308. If it has it, device B rejects the request in step 310. If it does not have it, device B further checks the message (packet) timeout in step 312, and, if the timeout has expired, eliminates the packet in step 321. If it has not expired, device B checks if the number of hops is greater than zero in step 313. If it is greater, the process goes to step 314. If it is not greater, device B eliminates Request R(A1,C) in step 321.

Device B then further checks if Request R(A1,C) includes its own (device's B) ID in step 314. If yes, the process advances according to criteria and parameters existing in device B in step 319. If no, device B checks if Request R(A1,C) includes its own (device's B) Group ID or Groups IDs in step 315. If yes, device B sends Request R(A1,C) as is in step 323 and the process advances according to criteria and parameters existing in device B in step 319. If no, in step 315, device B checks if it has matching information corresponding to “Info for R(A1,C)” message in step 316.

If such information is found, device B stores “Info for R(A1,C)” and sends it in step 317. and also sends on Request R(A1,C) as is in step 318. From step 317 the process continues to step 360 (FIG. 3a, see description ahead). If the corresponding information is not found, device B sends Request (A1,C) “as is” to be read by other devices in step 318. In other words, device B sends on Request (A1,C) in any case, regardless if matching information is found in step 316.

Device C receives Request R(A1,C) and stores it in step 320, checks if the same “Request R(A1,C)” packet already exists in it in step 322, and if it does (Yes), rejects the request in step 324. Device C then further checks the packet's timeout in step 326 and, if it has expired, eliminates Request R(A1,C) in step 325. If it has not expired, device C checks if the number of hops is greater than zero in step 327. If yes, the action goes to step 328. If no, it goes to step 325, where Request R(A1,C) is eliminated.

In step 328, device C checks if Request R(A1,C) includes its own (device C) ID. If yes, the process continues according to its criteria and parameters in device C in step 331. If no, device C checks if Request R(A1,C) includes its own Group ID or Groups IDs in step 329. If yes, it sends Request R(A1,C) “as is” in step 333 and the process continues according to device's C criteria and parameters in step 331. If no in step 329, device C checks if it has information matching “Info for R(A1,C)” in step 330, If such information is found, device C stores “Info for R(A1,C)” and sends it in step 332. and also sends on Request R(A1,C) “as is” in step 334. From step 332 the process continues to step 380 (FIG. 3b, see description ahead). If the matching information is not found in step 330, device C sends Request (A1,C) “as is” to be read by other devices in step 334.

The “Info for R(A1,C)” message sent by device B in step 317 is received and stored by device A in step 360. Device A now performs a series of steps 362-375 that replicate steps 308-323 done by device B, except that this time the handled packet is “Info for R(A1,C)” and not Request R(A1,C). In step 372, the packet is checked to see if a matching parameter (e.g. ID) in it matches the unique ID of device A. If yes, the process continues according to criteria and parameters existing in device A in step 374 If no, in step 373 the packet is checked to see if a matching parameter (e.g. a group ID) in it matches a Group ID or Groups IDs of device A. If the packet does not include or match any such Group ID or Groups IDs it is sent “as is” in step 376, to be received in other devices in the coverage range of device A, thereby perpetuating the transmission. If yes, request “Info for R(A1,C)” is sent “as is” in step 375 and the process continues according to device's A criteria and parameters existing in device A in step 374.

A similar procedure occurs for device B, which performs steps 380-396. If device B does not find its unique ID in step 392, the packet is checked to see if it includes or matches the Group ID or Groups IDs of device C. If the packet does not include or match any such ID, the “Info for R(A1)” packet is sent “as is” in step 396 and eventually received back in device A in step 400. Device A now performs a series of steps 402-416 that replicate steps 308-323 done by device B,

### SPECIAL COMMUNICATION PROTOCOL EXAMPLE

The SCP is a key inventive element of the present invention. As mentioned, the propagation of the electronic information between devices occurs without using any functions responsible for network route management and device recognition as part of the communication process. Consequently, the SCP of the present invention lacks all the elements that deal with network route management and device recognition functions, and which exist in any known network communication protocol. The autonomous data recognition mechanism (module 16) uses data elements handled by the SCP in order to perform data recognition.

The SCP defines the format of messages to be used by the data send and receive mechanism. Some of the bits in the format are left undefined for future use. The SCP defines the communication format between various types of system devices, some with “send and receive”, some with “send only” and some with “receive only” communication capabilities. The SCP also handles security encoding for those types of devices that carry a unique Identification Code (IC) and a secret number (secret code). The secret number may be inserted during device manufacturing or by a user or groups of users after manufacturing, and is used for encoding/decoding part of the messages. Note that the encoding/decoding may also be performed by other encryption methods.

The exemplary SCP described herein comprises (is divided into) the following layers: physical layer (level 0), data link layer (level 1) and transport layer (level 2). All numerical time values used herein below are for example purposes only, and other times may be actually used in various embodiments.

a) Physical Layer (level 0)

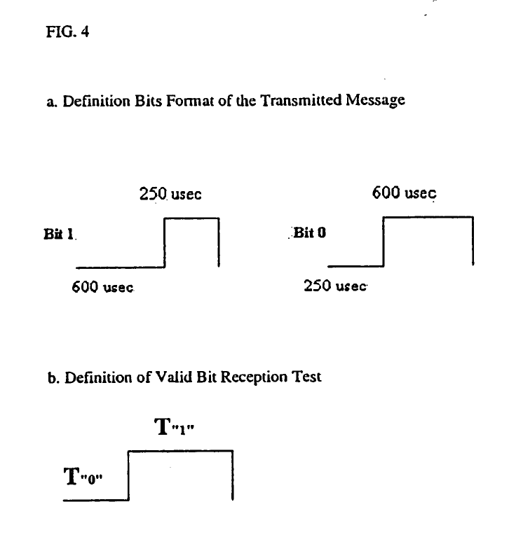

The types of transmitters and receivers in devices are determined by specific implementation requirements. During transmission of any message by the transmitter, the receiver may be turned to “low sensitivity” in order to enable the receiver to quickly recover and return to regular reception within a short time from the transmission end. FIG. 4 shows in (a) a definition of the bits format of the transmitted message and in (b) a definition of a valid bit reception test. Often, bits received at the receiver output are not identical with transmitted bits, and the change in the logical “0” and “1” time duration is very large. In addition, the receiver output may be noisy and valid bits may be also randomly identified without transmission. The following bit validation handles this situation:

A bit is considered to be a “valid” bit if all the following conditions exist:

40 usec<T“0 ”<1.1 Milliseconds

40 usec<T“1”<1.1 Milliseconds

T“0”+T“1”<1.4 Milliseconds

The bit value will be defined as “0” if T“1”>T“0”.

The bit value will be defined as “1” if T“1”<T“0”.

Checking Start Bit of Message Reception

A bit with a time duration of 1.8 Milliseconds. will be considered as a Start Bit.

Checking End of Message Reception

If a logical “0” is received at the receiver output for longer than 1.2 Milliseconds, it will be considered as the end of the bit sequence. It is then possible to analyze the number of the received bits and to decode the message. Since the messages length is not known in advance, the decision regarding the message end is made by measuring the time during which there is no reception. A state change with duration of less than 40 Milliseconds at the receiver output will be considered as an illegal spike and will be disregarded.

b) Data Link Layer (level 1)

This layer is responsible for the message transfer between the physical layer of level 0 and transport layer of level 2. It performs error detection, messages timing (flow control), retrying of messages not responded to and checking if a received message is really addressed to the receiving unit.

Transmission of Messages and Repeated Messages (Retry)

A device will start regular transmission only after performing a successful “clear air” check. The transmission will be performed by sending a message according to the required packet construction or structure (described below in level 2). If a device that sends a request for information (where a reply is expected) does not receive the information within 3000 Milliseconds, another message will be sent after performing a successful “clear air” test, and this procedure may be repeated again and again. Additionally, if the information is not received after this time, the same device will retransmit the message after 10000 Milliseconds.

If the device cannot perform a successful “clear air” test, it may be necessary to transmit “forced” transmissions by sending the messages to the air under any condition. This may happen because other device(s) within the coverage area are sending transmissions at the same time.

Similarly the protocol may also handle a received sent on message that already exists, as ACK (acknowledge) indicator, indicating that a message has been received by at least one other device in the same coverage range. When a message is sent and within a defined duration no equivalent sent on messages is being received, it will be regarded as an indication that no other device has received the message and it will be retransmitted using similar duration constraints done for the “clear air” check.

“Clear Air” Check

Whenever a valid message is received, a timer is reset to the value of 50 Milliseconds. If the timer was not reset and another message was received, the timer is reset again. The process may be repeated up to 8 times (400 Milliseconds maximum). The air will be considered “clear” for transmission if the timer was reset.

Repeated Message Reception (Message Elimination).

Upon reception, a message is checked to determine if it is identical to one of the messages received in the prior 100 Milliseconds. If yes, the message will not proceed for implementation by level 2 and will be eliminated.

Error Detection (CRC16)

The error detection is implemented exemplarily by a variation of a CRC16 algorithm of the CCITT standard. The CRC is calculated on all the bits received before the CRC bits. The CRC algorithm is as follows: unsigned int CCITT_CRC_TAB[256]={CCITT

CRC-16 Polynomial Table:

```
0x0000, 0x1021, 0x2042, 0x3063, 0x4084, 0x50A5, 0x60C6, 0x70E7,
0x8108, 0x9129, 0xA14A, 0xB16B, 0xC18C, 0xD1AD, 0xE1CE, 0xF1EF,
0x1231, 0x0210, 0x3273, 0x2252, 0x52B5, 0x4294, 0x72F7, 0x62D6
0x9339, 0x8318, 0xB37B, 0xA35A, 0xD3BD, 0xC39C, 0xF3FF, 0xE3DE,
0x2462, 0x3443, 0x0420, 0x1401, 0x64E6, 0x74C7, 0x44A4, 0x5485,
0xA56A, 0xB54B, 0x8528, 0x9509, 0xE5EE, 0xF5CF, 0xC5AC, 0xD58D,
0x3653, 0x2672, 0x1611, 0x0630, 0x76D7, 0x66F6, 0x5695, 0x46B4,
0xB75B, 0xA77A, 0x9719, 0x8738, 0xF7DF, 0xE7FE, 0xD79D, 0xC7BC,
0x48C4, 0x58E5, 0x6886, 0x78A7, 0x0840, 0x1861, 0x2802, 0x3823,
0xC9CC, 0xD9ED, 0xE98E, 0xF9AF, 0x8948, 0x9969, 0xA90A, 0xB92B,
0x5AF5, 0x4AD4, 0x7AB7, 0x6A96, 0xlA7l, 0x0A50, 0x3A33, 0x2A12,
0xDBFD, 0xCBDC, 0xFBBF, 0xEB9E, 0x9B79, 0x8B58, 0xBB3B, 0xAB1A,
0x6CA6, 0x7C87, 0x4CE4, 0x5CC5, 0x2C22, 0x3C03, 0x0C60, 0xlC4l,
0xEDAE, 0xFD8F, 0xCDEC, 0xDDCD, 0xAD2A, 0xBD0B, 0x8D68, 0x9D49,
0x7E97, 0x6EB6, 0x5ED5, 0x4EF4, 0x3E13, 0x2E32, 0xlE5l, 0x0E70,
0xFF9F, 0xEFBE, 0xDFDD, 0xCFFC, 0xBF1B, 0xAF3A, 0x9F59, 0x8F78,
0x9188, 0x81A9, 0xB1CA, 0xA1EB, 0xD10C, 0xC12D, 0xF14E, 0xE16F,
0x1080, 0x00Al, 0x30C2, 0x20E3, 0x5004, 0x4025, 0x7046, 0x6067,
0x83B9, 0x9398, 0xA3FB, 0xB3DA, 0xC33D, 0xD31C, 0xE37F, 0xF35E,
0x02Bl, 0x1290, 0x22F3, 0x32D2, 0x4235, 0x5214, 0x6277, 0x7256,
0xB5EA, 0xA5CB, 0x95A8, 0x8589, 0xF56E, 0xE54F, 0xD52C, 0xC50D,
0x34E2, 0x24C3, 0xl4A0, 0x0481, 0x7466, 0x6447, 0x5424, 0x4405,
0xA7DB, 0xB7FA, 0x8799, 0x97B8, 0xE75F, 0xF77E, 0xC71D, 0xD73C,
0x26D3, 0x36F2, 0x0691, 0xl6B0, 0x6657, 0x7676, 0x4615, 0x5634,
0xD94C, 0xC96D, 0xF90E, 0xE92F, 0x99C8, 0x89E9, 0xB98A, 0xA9AB,
0x5844, 0x4865, 0x7806, 0x6827, 0xl8C0, 0x08El, 0x3882, 0x28A3,
0xCB7D, 0xDB5C, 0xEB3F, 0xFB1E, 0x8BF9, 0x9BD8, 0xABBB, 0xBB9A,
0x4A75, 0x5A54, 0x6A37, 0x7A16, 0x0AF1, 0x1AD0, 0x2AB3, 0x3A92,
0xFD2E, 0xED0F, 0xDD6C, 0xCD4D, 0xBDAA, 0xAD8B, 0x9DE8, 0x8DC9,
0x7C26, 0x6C07, 0x5C64, 0x4C45, 0x3CA2, 0x2C83, 0x1CE0, 0x0CC1,
0xEF1F, 0xFF3E, 0xCF5D, 0xDF7C, 0xAF9B, 0xBFBA, 0x8FD9, 0x9FF8,
0x6E17, 0x7E36, 0x4E55, 0x5E74, 0x2E93, 0x3EB2, 0x0ED1, 0x1EF0
};
// Return the CCITT CRC-16 of the byte array. BufStart - pointer to start
of byte array.
// BufLen - Length of data.
unsigned int MSC_CalculateCRC(unsigned char * BufStart, unsigned
char BufLen)
{
unsigned int CRCres, V1;
unsigned char * BufPtr = BufStart;
for (CRCres = 0; BufPtr < (BufStart + BufLen); BufPtr++)
{
  V1 = (unsigned int)((CRCres >> 8) \hat{ } *BufPtr);
  CRCres = (unsigned int)((CRCres << 8) \hat{ } CCITT_CRC_TAB[V1]);
}
return (CRCres);
}
```

Data Encoding (Before Transmission)

The data encoding presented herein is exemplary only. Any other encryption method may be used. After CRC performance, in messages in which ENC bit =1, the DATA bytes are encoded by performing an XOR operation with the secret number mentioned above.

Data Decoding (After Reception)

Before CRC performance, in messages in which ENC bit =1 the DATA bytes are decoded by performing an XOR operation with the secret number. If after this XOR the CRC function detects an error, this message is not handled. If the CRC function detects an error in 4 subsequent identical messages, the error may be caused by a mismatch between the secret numbers of those messages and of the device, and therefore the receiving unit will transmit an ENC ERR bit=1 status signal.

c) Transport Layer (Level 2)

A message preferably comprises the following fields, shown in Table 2.

TABLE 2

| Frame | | Message | | | Sequence | | |
|---|---|---|---|---|---|---|---|
| control | INFO | expired | ID | Group ID | number | DATA | CRC |
| 23-46 bits | 4 bits | 6-8 Bits | 16-32 bits | 4-8 bits | 4-8 bits | 16-72 bits | 16 bits |

Each field is now described in detail.

Frame Control Protocol (Message Size and Structure)

| | |
|---|---|
| Start bit | |
| Receiving ID | 16-32 bits |
| Receiving group ID | 4-8 bits |
| Channel ID | 1-4 bits |
| Neighbor | 1 bit - “1” exist |
| Spare - for future use | 1 bit - “1” |

INFO Message Information (SPARE/ENC/ENE/MSG)

SPARE—“1”=for future use (1 bit)

ENC—“1”=encrypted message (1 bit)

ENE—“1”=encryption error (1 bit)

MSG—“1”=message segmented (1 bit)

Message Expired Message Validity

| | |
|---|---|
| Time restriction | 4 bits |
| Hops restriction | 2-4 bits |
| ID | Device ID 16-32 bits |
| Group ID | Device group ID 16-32 bits |
| Sequence Number | The number of the segmented packet 4-8 bits |
| DATA - | Data message 16-72 bits. Typically 16 bits, |
| | max. 72 bits. |
| CRC - | Error detection (CRC) |

Frame Control Explanation

Field Length (bytes) Description

| | |
|---|---|
| Start bit | Bit that indicate the start of the message |
| Receiving ID (*) | ID of receiving, 0 = broadcast |
| Group ID (*) | ID of device's own group |
| Channel ID 1 | RF channel ID number of |
| RX/TX | dedicated TCH (optional for multi channel) |
| Neighbor 1 | Used to know if there are other devices within |
| | cover range |
| Message X 0, | One or more message segments, segments |
| | of any type, originated or destined for any ID, |
| | which may include user data. |
| Time restriction | Time of message life cycle. |
| Hops number | Restriction number of hops |

(*) Address field sizes can be adjusted according to future criteria.

Duplicated Messages

To reduce the number of messages on the air and the devices' response times, the message ID is being checked, if the ID already exists in the device, the hop restriction is 0, or the time restriction is 0, then this packet will be eliminated and will not propagate.

Changing the Encoding of the Message and the Secret Number

a. Each device is assigned a 16-bit secret number

b. Before transmitting a message, the device creates a random number by performing an XOR operation on the data with the secret number. The result (encrypted random number) is transmitted as EDATA:[EDATA]=[secret number] [symbol] [data]

c. The device decodes the data by performing an XOR operation of EDATA with the secret number. DATA]=[EDATA] [symbol] [secret code]

d. The secret number is then used for encoding/decoding of the following messages (by level 1l), until the users or the group will change it per user or group.

In the present invention, the information is transmitted in a BROADCAST form each device, which means that any other device can receive the information. The system is free of using any routing tables, routing lists, paths or device recognition, therefore the system is free from checking the DESTINATION on the 2^{nd} layer of the OSI model (the DATA LINK) in order to enable sending information. When a device receives information, the analysis of which actions are to be taken is done according to the rules, criteria and parameters. Hence, there is no need to handle the information on the DLL, NETWORK, TRASPORT and SESSION layers in order to enable communication. The information will reach the devices as long as they are connected to a communication media through which the information is being transferred. Exemplarily, in a wireless environment, as long as a wireless device is within the coverage area, it receives the information from other devices.

As all communication protocols, the SCP of the present invention includes a synchronizing mechanism (not detailed) of the electronic information that in being sent and received by devices. The synchronization is done in order to ensure data completeness. The synchronizing mechanism may be selected from (but not limited to) time synchronization and symbol timing synchronization.

We reemphasize that the SCP described above is just an exemplary protocol that illustrates the inventive features of the present invention, i.e. the removal of those standard protocol elements that deal with device recognition, registration or administration. The present invention may use other protocols or protocol structures for handling, sending and receiving data, without handling any device recognition, registration or administration.

In summary, the present invention enables an exclusive connection between devices, in contrast with Larsen WO9856140 and U.S. Pat. No. 6,785,510. In order to enable connection between two devices via intermediate devices, Larsen's method requires that the sending device and intermediate devices contain indications of other device's unique identification as a prerequisite for sending the information. This prerequisite is mandatory since the sending device must know through which devices to send the information before sending it. In inventive contrast and advantageously, the present invention is free from such a prerequisite, since it sends the information with an enclosed ID of another device, relying on the sending and receiving propagation method. Receiving devices whose own ID does not match the enclosed ID send on the information, until a further receiving device identifies its own ID enclosed in the sent information and performs the corresponding action. The present invention's method is free from performing any identification or any of the prior art's indication process or mechanism in order to be able to send the information. The same applies for the receiving device, which identifies its own ID enclosed in the sent information: it is also free from performing any identification or any indication of the sending device or of any other intermediate device, in order to be able to receive the information.

Further inventively over prior art, the emphasis herein is on the information and not where it is located or who has it. Therefore, when devices send and receive information, they are completely free from the need to be aware of the presence of other devices as part of the communication process.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for creating spontaneous electronic information propagation and retrieval comprising the steps of:
a. by a first device, sending electronic information using a special communications protocol (SCP);
b. in at least one second device, receiving the electronic information;
c. in each second device in which the information was received, recognizing and analyzing the electronic information autonomously using the SCP , thereby obtaining autonomous analysis results; and
d. by each second device, performing at least one action in response to the autonomous analysis results;
whereby the SPC and the autonomous recognition and analysis of the information render the electronic information propagation and retrieval free of any need for device recognition, registration or administration and whereby the method is performed without including actions by a network coordinator.

2. The method of claim 1, wherein the step of recognizing and analyzing the electronic information autonomously includes analyzing the information independently of an action selected from the group consisting of controlled device management, device recognition, network routing and network control.

3. The method of claim 1, wherein the step of recognizing and analyzing the electronic information autonomously includes checking if the information already exists in the second device, and wherein the step of performing includes performing an operation selected from the group consisting of processing the information, storing the information, displaying the information and a combination thereof if the information already exists in the second device.

4. The method of claim 1, wherein the step of recognizing and analyzing the electronic information autonomously includes checking if the information already exists in the second device, and, if no, further checking if the information includes at least one matching parameter matching an internal parameter of the second device in which the information was received.

5. The method of claim 4, wherein, if an ID parameter match is found, the step of performing at least one action includes, by the second device, sending an appropriate message reflecting the match.

6. The method of claim 5, further comprising the step of receiving the appropriate message in the first device.

7. The method of claim 4, wherein, if a match is not found, the step of performing at least one action includes, by the second device, sending the electronic information as is using the simplified communications protocol and wherein the method further includes:
e. in at least one third device, receiving the electronic information;
f. in each third device in which the information was received, recognizing and analyzing the electronic information autonomously, thereby obtaining autonomous analysis results; and
g. by each third device, performing at least one action in response to the autonomous analysis results.

8. The method of claim 1, wherein the checking if the information includes at least one matching parameter includes checking if the information includes a parameter selected from the group consisting of identification (ID) parameters, informative content parameters and hierarchical identification parameters.

9. The method of claim 8, wherein an ID parameter is selected from the group consisting of a single unique ID and a group ID.

10. The method of claim 2, wherein the step of recognizing and analyzing the electronic information autonomously includes providing in each device a functionality operative to carry parameters, rules and criteria that determine the way in which received and sent information is searched, matched and manipulated.

11. The method of claim 10, wherein the providing in each device a functionality operative to carry parameters, rules and criteria includes providing rules and criteria selected from the group consisting of information filtering rules and sending permission rules.

12. The method of claim 11, wherein the rules and criteria are selected from the group consisting of search engines filter rules and criteria, e-mail filter rules and criteria and firewall application rules and criteria.

13. The method of claim 7, wherein the steps performed by each first, second and third devices are repeated by respectively at least one N^{th}, (N+1)^{th} and (N+2)^{th} device, wherein N is an integer ≧4.

14. A method for creating spontaneous electronic information propagation and retrieval comprising the steps of:
a. providing a plurality of devices, each device operative to perform autonomous data creation, recognition, analysis and communication; and
b. propagating the electronic information from device to device, wherein each device is free of any awareness of the presence of other devices while performing the propagation.

15. The method of claim 14, wherein the step of propagating the electronic information from device to device wherein each device is free of any awareness of the presence of other devices while performing the propagation includes propagating the electronic information from device to device wherein each device is free of recognition of and by any other device.

16. The method of claim 14, wherein the step of propagating the electronic information from device to device wherein each device is free of any awareness of the presence of other devices while performing the propagation includes propagating the electronic information wherein each device is free of registration with a communications network and free of management by the communications network.

17. The method of claim 16, wherein the propagating the electronic information wherein each device is free of registration with a communications network and free of management by the communications network includes propagation free of use, by the communications network, of routing tables, routing lists and device recognition.

18. The method of claim 14, wherein the step of propagating the electronic information includes using a special communication protocol (SCP) that comprises solely a physical layer, a data link layer and a transport layer.

19. The method of claim 18, wherein the using a SCP that comprises solely a physical layer, a data link layer and a transport layer includes using a simplified communication protocol.

20. A system for spontaneous electronic information propagation and retrieval comprising:
a. a plurality of devices, each operative to autonomously recognize and analyze sent and received electronic information; and
b. a propagation mechanism operative to propagate the electronic information from device to device, wherein each device is free of any awareness of the presence of other devices.

21. The system of claim 20, wherein the propagation mechanism includes a special communication protocol (SCP) comprising solely a physical layer, a data link layer and a transport layer,
whereby the SPC and the autonomous recognition and analysis of the information render the system free of any device recognition, registration or administration and whereby the system is free of a network coordinator or any device management element that operates as a mandatory condition for enabling the communication

22. The system of claim 21, wherein the SCP is a simplified communication protocol.

23. The system of claim 21, wherein each device includes an autonomous recognition mechanism operative to perform the autonomous recognition and analysis.

24. The system of claim 23, wherein at least one device includes a data send module for sending the electronic information and wherein at least one device includes a data receive module for receiving the electronic information.

25. The system of claim 24, wherein at least one device includes a data send and receive module for both sending and receiving the electronic information.

26. The system of claim 21, wherein the propagation mechanism includes a wireless communication mechanism, and wherein each device is operative to at least send or receive the electronic information using wireless communications.

27. The system of claim 21, wherein the propagation mechanism is operative to perform 1:1 communication, group communication and information retrieval,
whereby each device can communicate with other devices without the system having to establish any path or handshake as part of the communication process.

28. The system of claim 21, wherein a device is selected from the group consisting of a computer, a personal digital assistant, a mobile phone, a smart phone having computer capabilities, a smart object, a smart watch, a games console, a bio-chip, a chemo-chip, a wireless sensor node, a dedicated device and a combination thereof.

29. The system of claim 21, wherein the electronic information includes data selected from the group consisting of digital data, analog data and a combination thereof.
